(19) United States
(12) Patent Application Publication
(10) Pub. No.: US 2018/0050630 A1
(43) Pub. Date: Feb. 22, 2018

(54) CAPTIVE BEAM SYSTEM WITH ROTATING LATCH

(71) Applicant: Ancra International LLC, Azusa, CA (US)

(72) Inventors: Gregory A. Kauffman, Cincinnati, OH (US); H. Thomas Knox, Independence, KY (US)

(73) Assignee: Ancra International LLC, Azusa, CA (US)

(21) Appl. No.: 15/591,592

(22) Filed: May 10, 2017

Related U.S. Application Data
(60) Provisional application No. 62/376,322, filed on Aug. 17, 2016.
(60) Provisional application No. 62/469,941, filed on Mar. 10, 2017.

(51) Int. Cl. B60P 7/15

(52) U.S. Cl. CPC B60P 7/15

(57) ABSTRACT

A captive beam system is provided. The system includes a beam assembly comprising a beam and channel units at each end. The beam comprising a top surface that, when the captive beam system is installed, faces upward, wherein the top surface establishes a flat resting surface. Each channel unit supports a bracket and a pawl, the pawl is rotatable with respect to the first end of the channel unit. The pawl comprises a support surface that is configured, when the captive beam system is installed, to rest upon a bottom edge of an aperture disposed within a fixed track, wherein a vertical distance between the support surface and the flat resting surface of the beam is about 2.58 inches. An optional upper latch is configured to substantially prevent movement of the beam assembly in a direction along a long axis of an aperture of a fixed track.

### CROSS-REFERENCE TO RELATED APPLICATIONS

The present application claims the benefit of the filing date under 35 U.S.C. § 119(e) of U.S. Provisional Patent Application No. 62/376,322, filed Aug. 17, 2016, and of U.S. Provisional Patent Application No. 62/469,941, filed Mar. 10, 2017, the entirety of which are each fully incorporated by reference herein.

### TECHNICAL FIELD

This disclosure relates to captive beam systems for cargo compartments of trucks, aircraft, boats, railcars or fixed cargo compartments where the flexibility in the arrangement of beams for resting cargo thereupon is desired.

### BRIEF SUMMARY

A first representative embodiment of the disclosure is provided. The disclosure provides a captive beam system. The system includes a beam assembly comprising a beam and slidably receiving a first channel unit at a first end of the beam and slidably receiving a second channel unit at a second end of the beam, the beam comprising a top surface that, when the captive beam system is installed, faces upward, wherein the top surface establishes a flat resting surface. Each of the first and second channel units comprise a first end and a second end, the second end slidably engages a respective first or second end of the beam, the first end of each channel unit extends away from the respective end of the beam, the first end of each channel unit supports a bracket and a pawl, the pawl is rotatable with respect to the first end of the channel unit. The pawl comprises a support surface that is configured, when the captive beam system is installed, to rest upon a bottom edge of an aperture disposed within a fixed track, wherein a vertical distance between the support surface and the flat resting surface of the beam is about 2.58 inches.

Another representative embodiment of the disclosure is provided. The embodiment includes a captive beam system. The captive beam system includes a set of supports comprising first and second tracks each extending between first end and a second end, the first and second tracks each configured for fixed attachment to walls of a container, the first and second tracks both comprising a race disposed therealong and extending from the first end at least to a position proximate to the second end of the respective support, and each of the first and second supports comprising a plurality of aligned apertures disposed through a center wall of the support with the plurality of apertures each comprising a bottom edge. A beam assembly comprises a beam and slidably receiving a first channel unit at a first end of the beam and slidably receiving a second channel unit at a second end of the beam, the beam comprising a top surface that, when the captive beam system is installed, faces upward, wherein the top surface establishes a flat resting surface. Each of the first and second channel units comprises a first end and a second end, the second end slidably engages a respective first or second end of the beam, the first end of each channel unit extends away from the respective end of the beam and engages a respective one of the first and second supports, the first end of each channel unit supports a bracket and a pawl, the pawl is rotatable with respect to the first end of the channel unit. The pawl comprises a support surface that is configured, when the captive beam system is installed, to rest upon the bottom edge of one of the plurality of apertures in the respective support, wherein a vertical distance between the support surface and the flat resting surface of the beam is about 2.58 inches.

Another embodiment of a captive beam system to be installed along at least one fixed track with at least one aperture with an upper edge and a bottom edge spaced apart from the upper edge and a long axis extending between the upper edge and the lower edge is disclosed. The beam system includes a beam assembly with a beam that slidably receives a first channel unit at a first end of the beam and slidably receives a second channel unit at a second end of the beam. The beam further includes a top surface that, when the captive beam system is installed, faces upward, wherein the top surface establishes a flat resting surface, and wherein each of the first channel unit and the second channel units includes a first end and a second end spaced apart from the first end. The second end of each of the first channel unit and the second channel unit slidably engages a respective first end and second end of the beam. A bracket is coupled to one of the first end of the first channel unit and the first end of the second channel unit. A pawl is configured to be rotatable with respect to the bracket. The pawl includes a support surface that is configured, when the captive beam system is installed, to rest upon the bottom edge of the at least one aperture. In addition, an upper latch is configured to be rotatable with respect to the bracket. The upper latch includes a first extension with a stop surface that is configured, when the captive beam is installed, to lie proximate to the upper edge of the at least one aperture so as to substantially prevent movement of the beam assembly in a direction along the long axis of the aperture.

Other systems, methods, features and advantages of the invention will be, or will become, apparent to one with skill in the art upon examination of the following figures and detailed description. It is intended that all such additional systems, methods, features and advantages be within the scope of the disclosure, and be encompassed by the following claims.

### BRIEF DESCRIPTION OF THE DRAWINGS

FIG. 1 is a side view of a beam assembly extending between vertical logistics tracks on opposite sides of a cargo compartment.

FIG. 2 is a side view of a channel unit of the beam assembly of FIG. 1 extending from a track.

FIG. 3 is a top view of FIG. 2.

FIG. 4 is a front view of a portion of the track of FIG. 1.

FIG. 5 is a cross-sectional view of a beam of the beam assembly of FIG. 1.

FIG. 6 is a cross-sectional view of the track of FIG. 4 about section A-A.

FIG. 6a is a cross-sectional view about section A-A of FIG. 4 of an alternate track.

FIG. 7 is a perspective view of the channel unit of FIG. 2.

FIG. 8 is an exploded view of the channel unit of FIG. 2.

FIG. 9 is an exploded view of the bracket and pawl of the channel unit of FIG. 2.

FIG. 10 is a side view of the pawl of the channel unit of FIG. 2.

FIG. 11 is a side view of the pawl and the bracket pinned together, showing the hidden tab and the hidden spring biasing the pawl in the direction Z.

FIG. 12 is a detail view of detail A of FIG. 5.

FIG. 13 is a front view showing the beam assembly of FIG. 1 disposed in a track neighboring a track that supports a conventional E-beam, with the beam assembly and the E-beam disposed upon apertures at the same height above the floor of the cargo compartment.

FIG. 14 is a perspective view of another embodiment of a bracket and a pawl in a latched configuration with a track for use with the beam assembly of FIG. 1.

FIG. 15 is a view of cross-section B-B of FIG. 14.

FIG. 16 is a perspective view of the bracket and the pawl of FIG. 14 in an unlatched configuration.

FIG. 17 is a view of cross-section C-C of FIG. 16.

### DETAILED DESCRIPTION

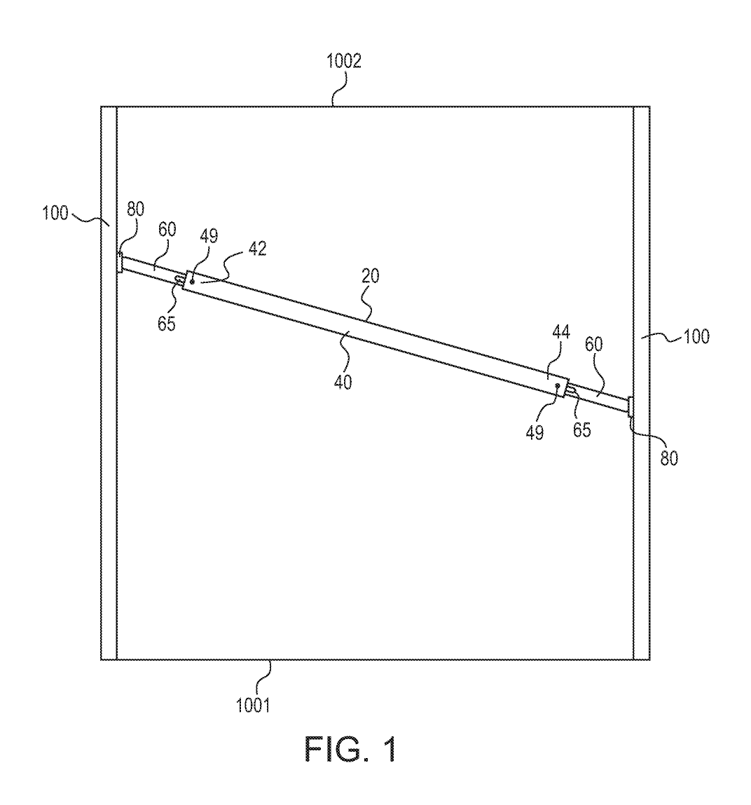

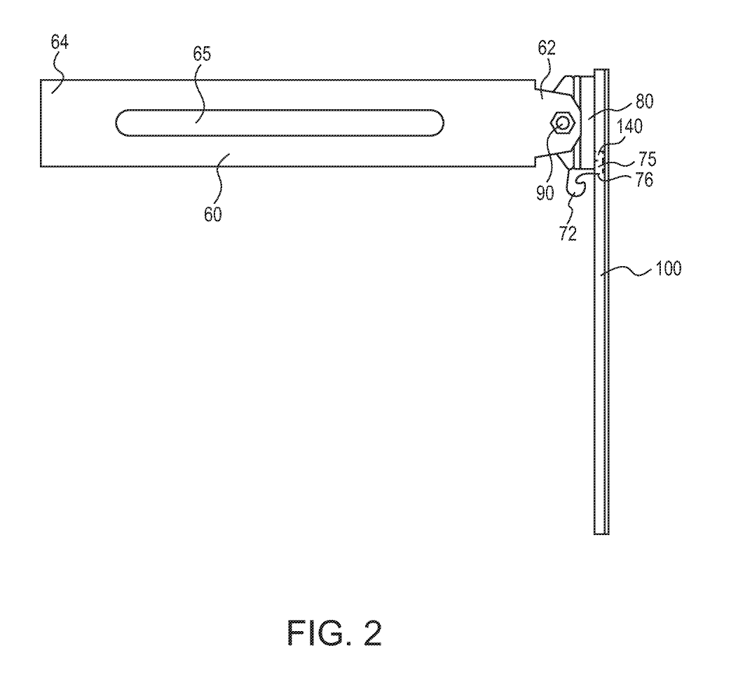

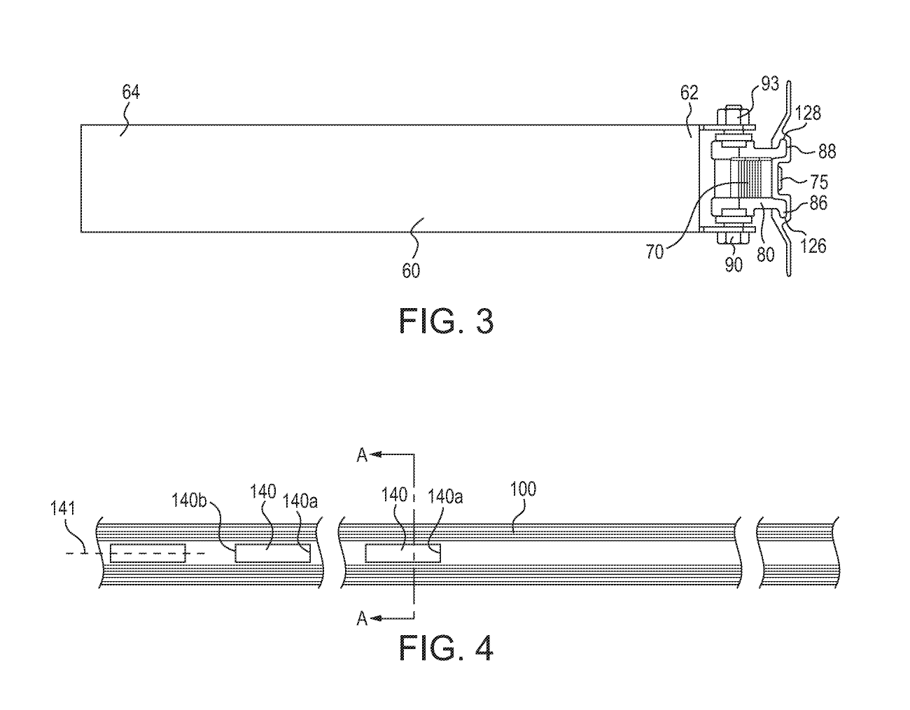

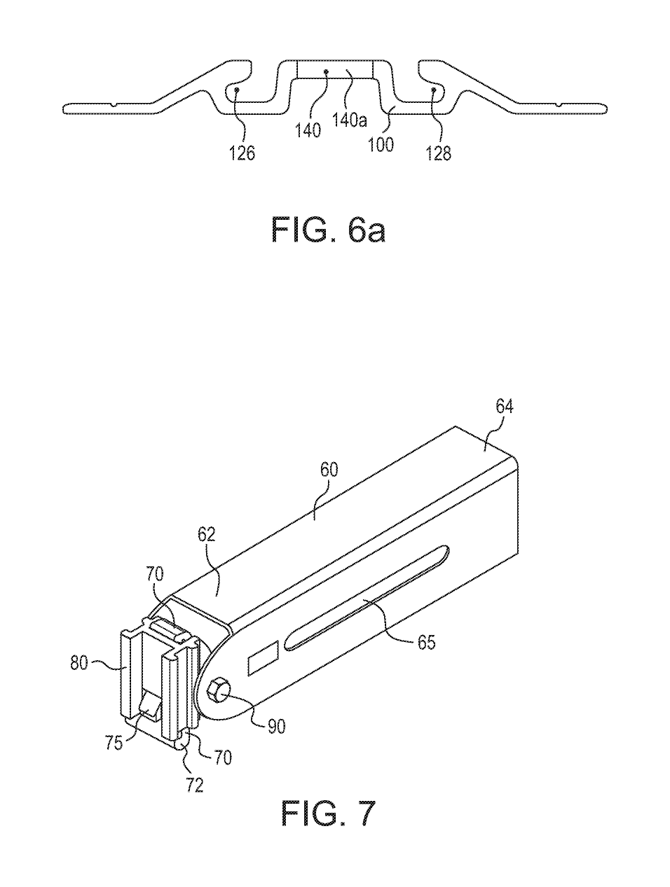

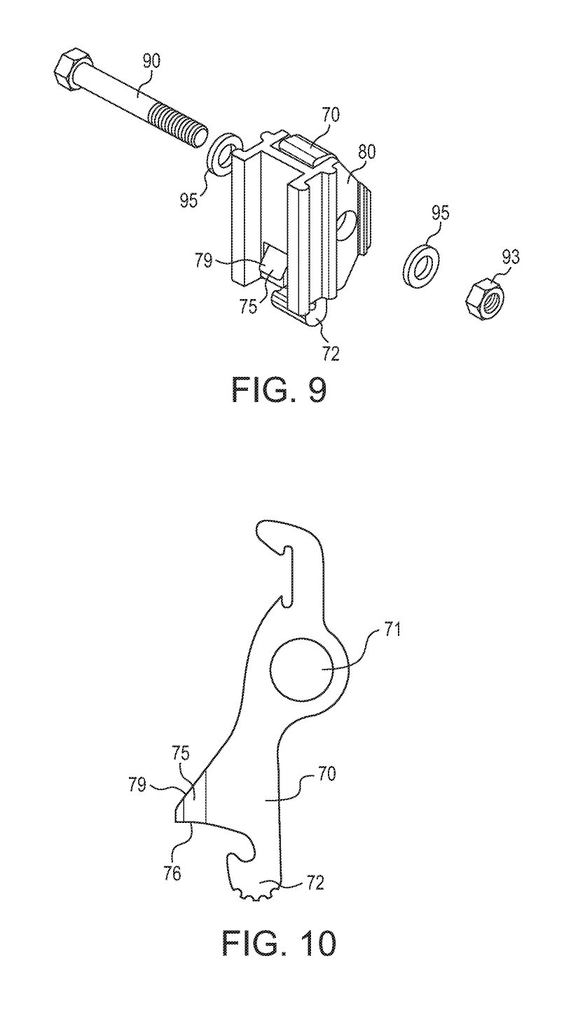

Turning to FIGS. 1-11 a captive beam system 10 is provided. The captive beam system 10 is configured to be installed within an enclosure, such as the cargo compartment of a truck, a railroad car, an aircraft, a boat, or upon other enclosures, such as shipping containers or the like. The captive beam system 10 can be disposed upon any structure with opposed vertical walls that are disposed in parallel to each other. While the captive beam system 10 can be successfully implemented in various different environments, the system will be described herein with respect to the cargo compartment of a conventional commercial semi-trailer. Any differences in the construction of the captive beam system for other environments will be specifically discussed herewithin.

The captive beam system 10 is configured to include a beam assembly 20 that is slidably received upon two opposed vertical tracks 100, which are often referred to as logistics tracks. The beam assembly 20 includes a beam 40 that receives a channel unit 60 on one or both of the first and second ends 42, 44 of the beam assembly 40. Each channel unit supports a bracket 80 that engages and rides within two or more races 126, 128 (or a single race) in the respective track, or vertical support 100, and a pawl 70 that selectively engages an aperture 140 within the track 100 to fix the beam assembly 20 at a selected position with respect to the track 100.

The track 100 may extend from the floor 1001 to the ceiling 1002 of a cargo compartment 1000, or to a position proximal to one or both of the floor or ceiling. The track 100 may include a plurality of apertures 140 that are disposed at consisting spacing from neighboring apertures 140 along the entire length of the track, or in some embodiments, the spacing of neighboring apertures may be consistent along a portion of the length of the track 100, or the apertures may be disposed upon the track in other arrangements that may be appropriate for positioning of a beam assembly 20 disposed thereon within the cargo container. For example, a long axis 141 of each aperture 140 is parallel and, optionally, coincident with a long axis of the track 100. In other embodiments, however, a long axis of each aperture 140 may be aligned at an angle and, in some instances, perpendicular to, a long axis of the track 100 (not illustrated). Each of the apertures 140 in the track 140 may include a bottom edge 140a, which in some embodiments is disposed along the geometric bottom of the aperture 140, while in other embodiments the bottom edge 140a may be along a portion of the geometric bottom of the aperture 140 but also along another portion of the aperture 140. Alternatively, the bottom edge 140 may be disposed along another location of the aperture to support a tab 75 of a pawl 70, such that the tab 75 is fixed to the aperture 140 as discussed below. Each aperture 140 also optionally includes an upper edge 140b spaced apart from the bottom edge 140a. In some embodiments, the upper edge 140b is disposed along the geometric top (i.e., closer to the ceiling 1002) of the aperture 140, while in other embodiments the upper edge 140b may be along a portion of the geometric top of the aperture 140 but also along another portion of the aperture 140.

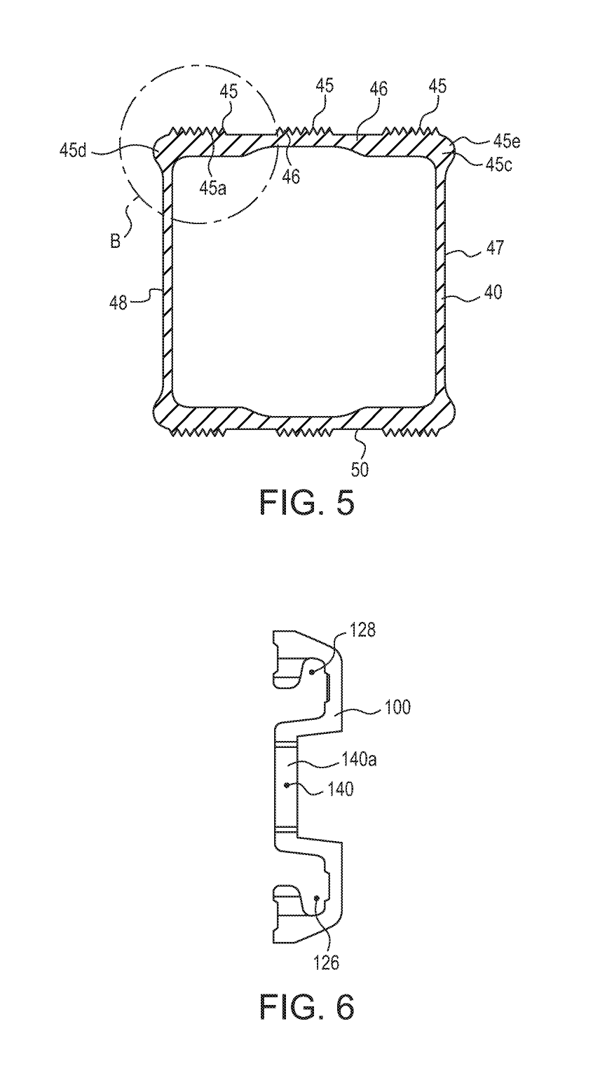

In some embodiments, the entire length of the beam 40 between its first and second ends 42, 44 is hollow (FIG. 5), where in other embodiments one or both of the first and second ends 42, 44 of the beam 40 is hollow, with remaining portions of the beam either being of solid cross-section, or including internal structural features, such as ribs, to provide for additional strength of the beam 40. In other embodiments, one or both of the first and second ends 42, 44 of the beam includes an alignment feature that allows for engagement of a corresponding alignment feature upon the respective channel unit 60 to allow the channel unit 60 to rigidly support the beam 40 but to also allow relative longitudinal sliding between the beam 40 and the channel unit 60, with the result that the overall length of the beam assembly 20 changes as the beam 40 and channel unit 60 slide with respect to each other. This allows the overall length of the beam assembly 20 to change, such as when one channel unit 60 is slid upwardly or downwardly upon its track 100 with the other channel unit 60 remaining in a fixed position upon the opposite track 100. In embodiments where the beam 40 is hollow and the first ends 62 of the channel units 60 extend within the respective hollow beam 40, the channel units 60 and the beam 40 can slide with respect to each other.

In some embodiments, the one or both of the hollow first and second ends 42, 44 a second end 64 of a channel unit 60 is telescopingly received within the respective hollow end portion 42, 44 of the beam. In this embodiment, the channel unit 60 may include an elongate slot 65 disposed through one or both right and left side walls, with the end portion 42, 44 of the beam including an aperture upon one or both of the rights and left side walls of the beam, with a fastener 49 that extends therethrough. This arrangement maintains a connection between the beam 40 and the channel unit 60 yet allows freedom for longitudinal, telescoping sliding therebetween to allow for the overall length of the beam assembly 20 to change, such as to allow one end of the beam assembly to be moved up or down the vertical support 100 that the channel unit 60 is connected to while the other end of the beam assembly remains stationary upon its vertical support 100.

The beam 40 is best shown in FIG. 5. The beam 40 includes a top surface 46 that faces upward (i.e. toward the ceiling of the cargo container when the beam is installed and is positioned horizontally) and a flat resting surface 45 that extends along at least a majority of the length of the beam 40 and in some embodiments the entire length of the beam between the first and second ends 42, 44. The flat resting surface 45 is the surface upon which cargo that rests upon the beam 40 engages. In some embodiments, the flat resting surface 45 may be a planar surface, while in other embodiments, the flat resting surface 45 may have features thereon, such as a roughened surface such as to increase friction between the cargo resting upon the beam 40 and the flat resting surface 45 to minimize relative movement, or for other reasons, such as to increase strength, reduce weight, or to maximize a strength to weight ratio of the beam 40.

In some embodiments depicted in FIGS. 5 and 12, the flat resting surface 45 may include a collective planar surface formed by a plurality of formations upon the beam 40, which may also include a plurality of other formations that are disposed upon the top surface 46 that do not contribute to the flat resting surface 45, such as a plurality of recessed surfaces that drop below the flat resting surface 45. The beam 40 may include a plurality of parallel ridges 45a, the tops of which are each aligned and collectively form the flat resting surface 45 and a plurality of valleys 45b between the ridges 45a. In some embodiments, the ridges 45a and valleys 45b extend along the length of the beam 40 between the first and second ends 42, 44 such that the beam 40 may be extruded with these features. In other embodiments, the ridges 45a and valleys 45b (or other structures) may be oriented in other positions or directions relative to the length of the beam 40, such as perpendicular or at an acute or obtuse angle with respect to the longitudinal axis 40a of the beam 40.

In some embodiments, the flat resting surface 45 may extend across the entire top surface 46 of the beam 40, while in other embodiments the flat resting surface 45 may extend only upon a portion of the top surface 46 of the beam 40, with other portions of the top surface 46 of the beam surrounding the flat resting surface 45, such as disposed outboard on one or both sides of the beam 40. In some embodiments the other portions (that do not form or contribute to the flat resting surface 45) may be outboard of the flat resting surface 45 proximate to one or both ends 42, 44 of the beam. The remaining top surface may be aligned at a constant height (vertically below the flat resting surface 45) or in other embodiments the remaining top surface may extend to different heights and or with different geometries, surface finishes, materials, and the like.

The beam 40 may additionally include opposed right and left side surfaces 47, 48 that each extend from opposite right and left side edges 45c, 45d of the flat resting surface 45 (or edges of the top surface 46). In some embodiments, the right and left side surfaces 47, 48 may extend directly from the respective right and left side edges 45c (FIG. 12), 45d, such that the two surfaces form a perpendicular angle with respect to each other. In embodiments, wherein the top surface 46 of the beam 40 includes surfaces 45e outboard of the flat resting surface 45, the opposed right and left side surfaces 47, 48 may form an edge with the portions of the top surface 45e disposed outboard of the flat resting surface 45. The beam 40 may additionally include a bottom wall 50 that connects with one or both of the right and left surfaces 47, 48. In some embodiments, the bottom wall 50 may be formed with same geometry and design (such as with the same materials, surface finish, etc.) as the top surface 46 of the beam (i.e. so that the beam forms a bottom flat resting surface, that is like the top flat resting surface) so that the beam 40 can be installed in either orientation, to allow for continued use of the beam 40 by flipping it over so that the initial bottom surface 50 is now oriented as the top surface (i.e. facing the ceiling of the container when horizontally aligned) if its original top flat resting surface 45 became marred or damaged by use.

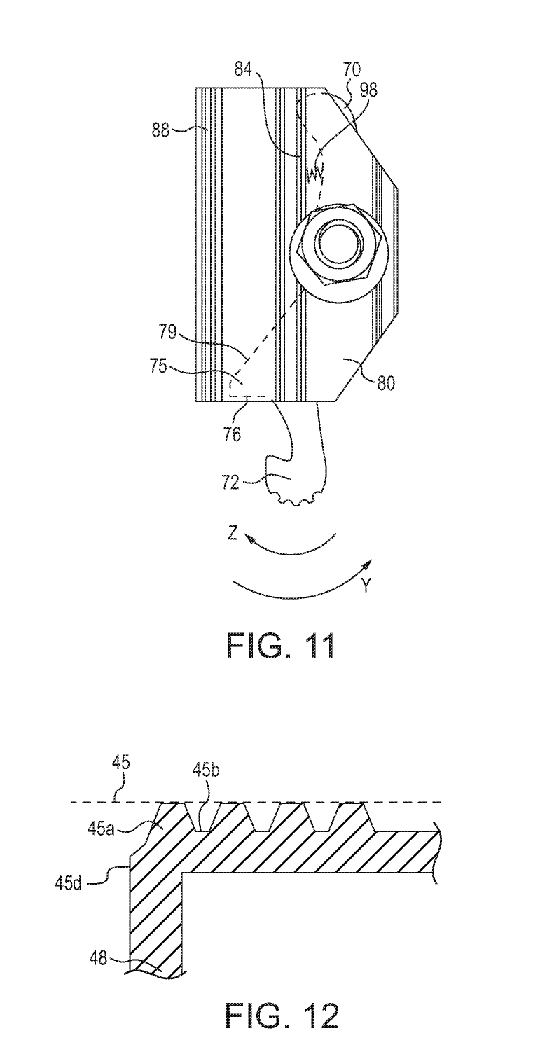

The pawl 70 is rotatably attached to the channel unit 60 with a pin 90 that extends through an aperture 63 in the first end portion 62 of the channel unit 60. In some embodiments, first end portion 62 of the channel unit 60 may have two extended portions of the respective right and left walls 66a, 66b and the aperture 63 may extend through both of these extended walls. The pawl 70 is provided to be pivotable about the pin 90 and a spring 98 may be provided to bias the pawl 70 in a direction Z (as shown in FIG. 11) such that the tab 75 of the pawl 70 is urged toward the track 100 and specifically (when properly aligned) within an aperture 140 within the track 100. The pawl 70 may include an operator 72 that is disposed at the bottom of the pawl 70 and is configured to be manipulable by the user, either directly with the user's fingers or with a tool, to urge the pawl 70 to rotate in the opposite direction Y (FIG. 11) which pulls the tab 75 away from the track 100 and specifically the aperture 140. In some embodiments, the operator 72 is disposed at the bottom of the pawl 70, and on an opposite side of the support surface (discussed below) from hole 71 through the pawl 70 that the pin 90 extends through. In other words, the operator 72 and the tab 75, which includes the support surface 76, move in the same direction as each other. In some embodiments, the pawl 70 is biased with respect to the channel unit 60 such that the operator 72 is biased away from the first end 62 of the channel unit 60.

In some embodiments, the front of the tab 75 (i.e. the portion of the tab 75 that extends in a cantilevered fashion from the body of the pawl 70) may have a top surface 79 that is chamfered or angled such that the tab 75 is urged out of an aperture 140 when the bracket 80 and the pawl 70 is moved along the track 100 and the chamfered surface 79 comes into contact with the top edge 140b of an aperture 140.

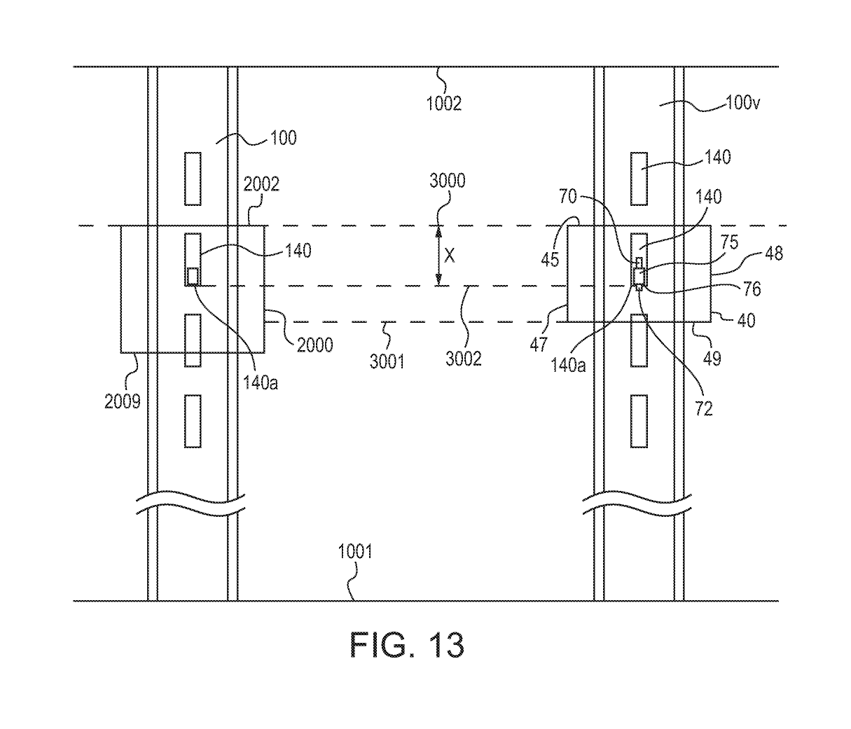

The tab 75 of the pawl 70 may include a support surface 76 that forms the bottom surface of the tab, and the support surface 76 engages a bottom edge 140a of the aperture 140 of the track 100 when the tab 75 extends within an aperture 140. As shown in FIG. 13, when the tab 75 is aligned for extension within an aperture 140, the support surface 76 is a predetermined vertical distance X from the flat resting surface 45 of the beam so that the flat resting surface 45 is at a predetermined vertical position with respect to the aperture 140 of the track. In some embodiments, this predetermined vertical distance is 2.58 inches. In other embodiments, the predetermined vertical distance is about 2.58 inches, with about defined to be plus or minus 0.25 inches from the distance specified. In other embodiments, this predetermined vertical distance X may be different when the beam assembly 20 is desired to be potentially used in conjunction with other types of beams (other than E-beam) as discussed below.

As shown in FIG. 13, the predetermined vertical distance X is established such that the flat resting surface 45 of the beam assembly 20 (when the beam 40 is aligned horizontally) is aligned along the same horizontal plane 3000 as the top surface of a conventional E-beam, when the E-beam is installed onto a neighboring track 100 within the cargo container and specifically aligned within an aperture 140 within the neighboring track that is at the same vertical position as the aperture 140 upon which the channel unit 60 is aligned with. In other embodiments where the captive beam system 10 could be used in conjunction with other conventional removable decking beam designs, and therefore the predetermined vertical distance X could be other values, based upon the design of the other conventional decking beam, and specifically the distance between the point of contact between the conventional beam and the support surface or aperture (e.g. 140) in the vertical logistics track, such that the conventional beam and the flat resting surface of the respective beam assembly would be aligned along the same horizontal plane. With a thorough review of this specification, one of ordinary skill in the art, who would be familiar with the standard dimensions of the conventional decking beam desired to be used would be able to construct the captive beam system such that the predetermined vertical distance X would provide for the flat resting surface 45 to be aligned along the same horizontal plane as the top surface of the conventional beam, without undue experimentation.

In some embodiments shown in FIG. 13, the cargo compartment 1000 includes an environment with a plurality of identical vertical tracks 100 disposed along the same wall, wherein at least two of the plurality of identical vertical tracks 100 are disposed such that a bottom edge 140a of an aperture 140 in the at least two vertical tracks is disposed at the same vertical height above a floor 1001 of an enclosure (as depicted by line 3002), such that when a conventional E-beam 2000 is engaged with the bottom edge 140a of the aperture 140 in a first of the at least two vertical tracks 100, and the beam assembly 20 is disposed such that the support surface 76 of the pawl 70 is engaged with the bottom edge 140a of the aperture 140 in the second of the at least two vertical tracks 100, a top surface 2002 of the E-beam is disposed along a horizontal plane 3000 with the flat resting surface 45 of the beam 40. In some embodiments, the beam assembly 20 may be formed to be “low profile” such that the bottom surface 50 of the beam 40 is above the bottom surface 2009 of a conventional E-beam when positioned upon the same aperture 140 as the beam assembly 20 (as depicted as line 3001).

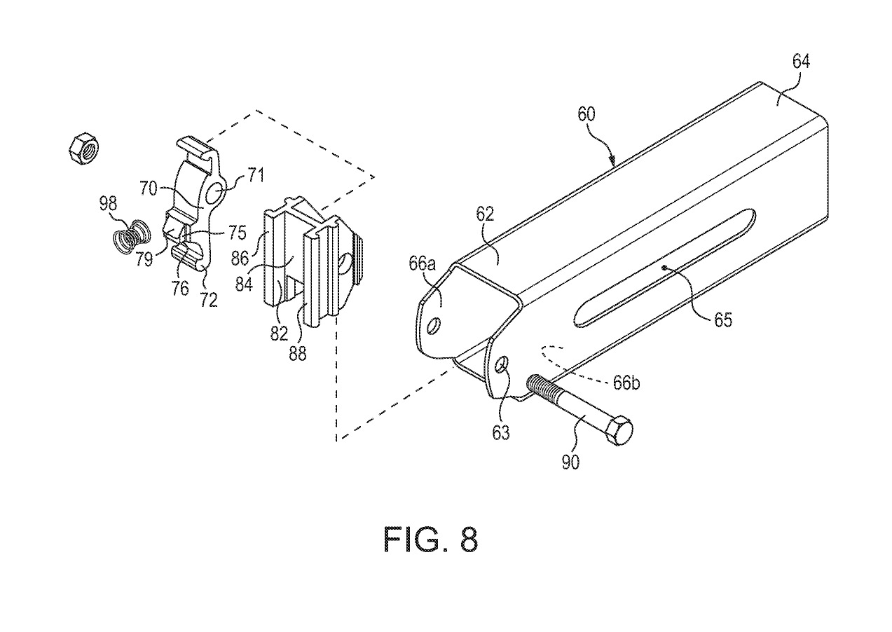

The bracket 80 may be attached to the channel unit with the pin 90 that pivotably supports the pawl 70. The bracket 80 is rotatable with respect to the first end 62 of the channel unit 60 as well as the pawl 70. As best shown in FIGS. 8 and 11, the bracket 80 may include a center member 84 and two or more feet 86, 88 that when positioned upon the track 100, ride within the corresponding races 126, 128 of the track 100, which aligns the bracket 80 and then therefore the channel unit 60 along the track 100 and allows the channel unit 60 to slide upward and downward along the track 100 until it reaches a desired position. In some embodiments, the feet 86, 88 extend away from each other and (when installed within the track 100) within opposite races 126, 128 that are on opposite sides of the track 100. In embodiments where the track 100 only has a single race, the bracket 80 would also have only a single foot. As discussed above, when the channel unit 60 reaches the desired position, the tab 75 extends into the corresponding aperture 140 in the track and the support surface 76 rests upon the bottom edge 140a of the track that defines the aperture 140. The center member 84 of the bracket 80 is a bearing surface that a spring 98 engages, as well as engaging a portion of the body of the pawl 70 to bias the tab 75 of the pawl 70 toward the track 100 and specifically within the aperture 140 when the channel unit 60 is aligned therewith.

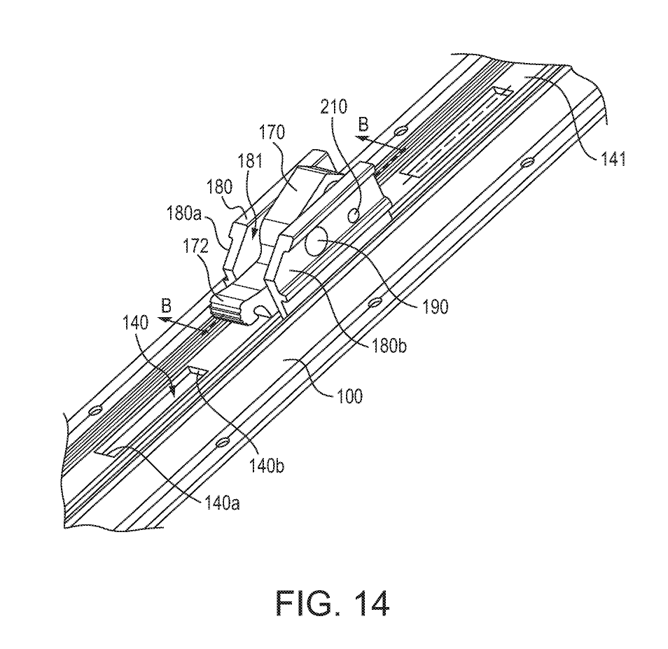

Another embodiment of the captive beam systems include those with another embodiment of the bracket 180 and pawl 170 illustrated in FIGS. 14-17 as will be discussed below. Unless otherwise identified expressly, the bracket 180 and pawl 170 is capable of being used with the track 100 as discussed above. Further, the bracket 180 and the pawl 170 optionally include any of the features of the bracket 80 and the pawl 70 described above even if those features are not expressly recited again below.

The bracket 180 includes a first side 180a and a second side 180b spaced apart from the first side 180a to form a channel 181 into which the pawl 170 is received. The first side 180a and the second side 180b are coupled together via a center member 184 and, optionally, a rear member 185 that is spaced apart and separated from the center member 184 by an opening 183. The bracket 180 is configured to be coupled to the track 100 with the optional various structures and in the manner described above.

A hole (not labeled) through the first side 180a and the second side 180b is configured to receive a pin 190 that rotatably couples the pawl 170 to the bracket 180 and that rotatably couples the bracket 180 to the first end 62 of one of the channel units 60.

The pawl 170 is configured to be rotatable with respect to the bracket 180 about the pin 190 that is inserted through the hole 171. Similar to the pawl 70 discussed above, the pawl 170 includes a tab 175 with a support surface 176 that is configured when the captive beam system is installed to rest upon the bottom edge 140a of the at least one aperture 140 of the track 100.

The pawl 170 also comprises an operator 172 similar in structure and operation to the operator 72 discussed above. The operator 172 is positioned in a spaced position from a support surface 176, and on an opposite side of the support surface 176 from a position where the pawl 170 rotatably connects to the channel unit 60.

The pawl 170 optionally includes an upper end 173 spaced apart from the operator 172. The upper end 173 includes a recess 177 on a lower surface 174. The recess 177 is configured to receive a central portion or body 192 of an upper latch 191 when the support surface 176 of the pawl 170 does not rest upon the lower edge 140a of the aperture 140 (i.e., when the pawl 170 is moved in the Y-direction as indicated in FIG. 11 into its unlatched position; stated differently, the pawl 170 is positioned so as to permit the bracket 180 to be moved in a direction along the long axis 141).

A difference in the pawl 170 as compared to the pawl 70 is that the pawl 170 includes the upper latch 191 that, in some embodiments, is configured to interact with the pawl 170 and the track 100.

The upper latch 191 is configured to be rotatable about an axis of rotation with respect to the bracket 180. A pin 210 is configured to be received in a hole (not labeled) in the first side 180a and the second side 180b and through a hole 193 through the central portion or body 192 of the upper latch 191. Thus, in some embodiments the pawl 171 and the upper latch 191 are rotatable relative to the bracket 180 around different axes of rotation.

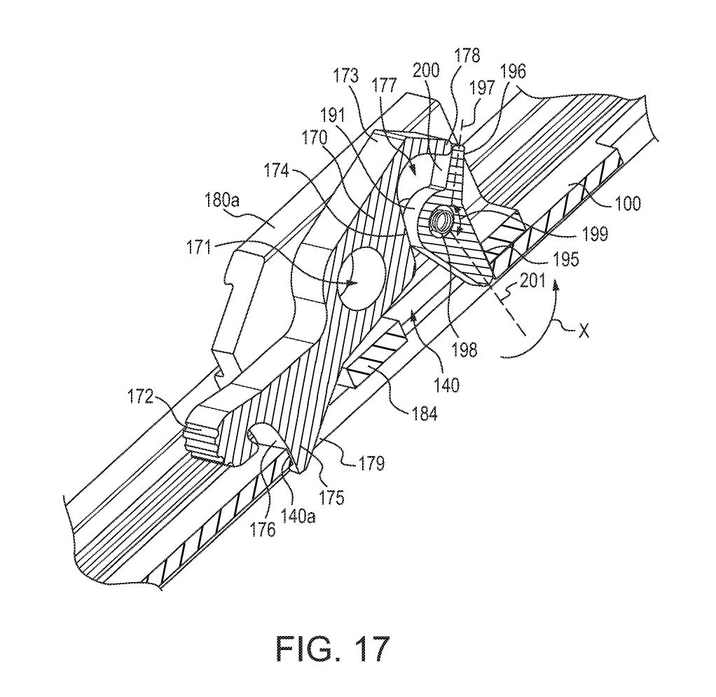

The upper latch optionally includes a first extension 194 extending away from the central portion or body 192 along an axis 201. The axis 201 may, in some embodiments, intersect the rotational axis or center of the hole 193. The first extension 194 includes a stop surface 195 (FIG. 17) that is configured, when the captive beam is installed, to lie proximate to the upper edge 140b of the at least one aperture 140 so as to substantially prevent movement of the beam assembly in a direction along the long axis 141 of the aperture 140. In some instances, the stop surface 195 abuts the upper edge 140b while in others the stop surface 195 may simply lie proximate to the upper edge 140b. Regardless of the precise disposition of the stop surface 195 relative to the upper edge 140b, the stop surface 195 interacts with the upper edge 140b so as to prevent the beam assembly from moving more than 0.5 inches in a direction along the long axis 141 of the aperture 140 when the upper latch is in its latched position (FIG. 17). Thus, the pawl 171 substantially prevents movement of the bracket 180 in either direction along the axis 141 by virtue of the support surface 176 resting upon the bottom edge 140a and the stop surface 195 interacting with the upper edge 140b.

Optionally, the upper latch 191 includes a second extension 196 extending away from the central portion or body 192 along a second axis 197. The second axis 196 intersects the first axis 201 of the first extension 194 at an angle 198. The angle 198 may be acute, obtuse, or 90 degrees.

As with the pawl 70, the pawl 170 includes a biasing mechanism 199 (FIG. 17) coupled to one of the pawl 170 and the upper latch 191. For example, the biasing mechanism 199 may be positioned between one of the center member 184 and the rear member 185 of the bracket 180 and one of the lower surface 174 of the pawl 170 and the second extension 196.

In other embodiments, the biasing mechanism 198 may be a torsion spring coupled to the upper latch 191 that urges the upper latch 191 to rotate in a direction X. The rotation of the upper latch 191 in turn causes an engagement surface 200 of the second extension 196 to interact with a pawl engagement surface or pawl extension 178 of the pawl 170 and thereby urge the operator 172 to move in the direction Z (FIG. 11). In other words, the upper latch 191 and the pawl 170 are rotatably coupled, i.e., as the upper latch 191 rotates about its axis of rotation the pawl 170 simultaneously rotates about its axis of rotation.

Regardless of the particular type and arrangement, the biasing mechanism 198 is configured to urge the operator 172 away from the channel unit 60 and towards the fixed track 100.

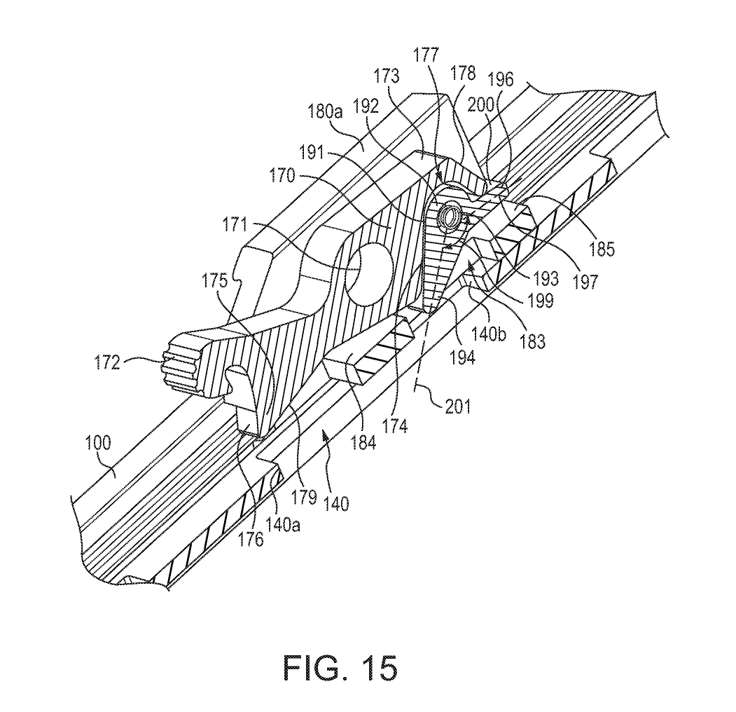

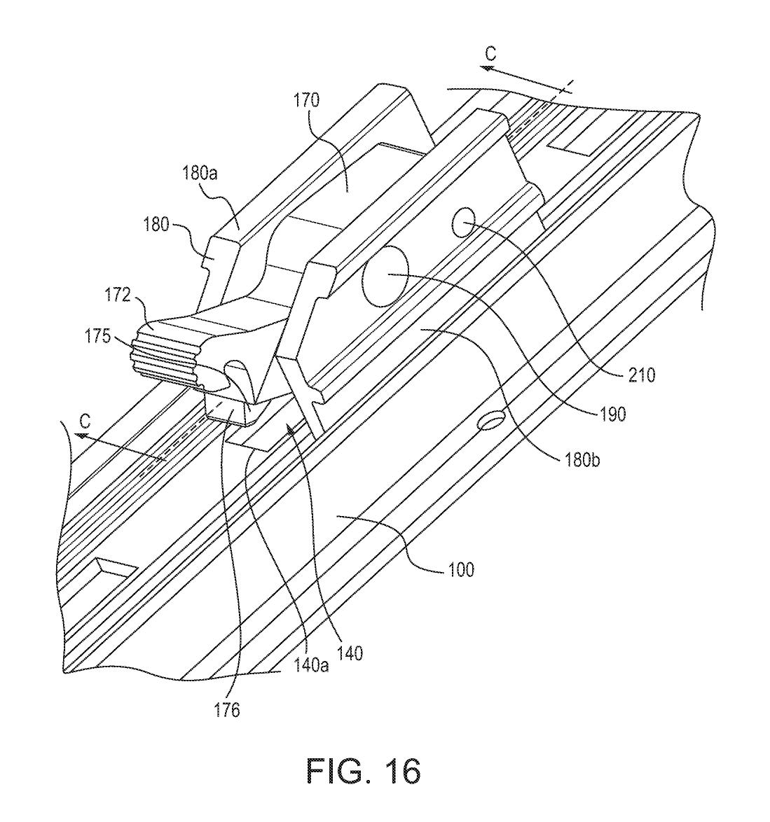

The bracket 180 and the pawl 170 are configured to be moved along the track 100 much like the bracket 80 and pawl 70 as discussed above. When a user manipulates the operator 172 so that the support surface 176 no longer rests upon the lower edge 140a of the aperture 140, the pawl engagement surface 178 interacts with the engagement surface 200 of the second extension 196 to rotate the upper latch 191 to its unlatched position (FIG. 15). The rotation of the latch 191, in turn, rotates the first extension 194 away from its proximate position near or adjacent to the upper edge 140b of the aperture 140. Thus, with one movement of the operator 172, the bracket 180 and the pawl 170 is now capable of being moved in either direction along the long axis 141 of the aperture 140.

Alternatively, if the user only wishes to move bracket 180 and the pawl 170 upwards (i.e., in a direction along the long axis 141 towards the upper edge 140b), the user merely needs to apply sufficient force to overcome the force of the biasing mechanism 198. More specifically, as the user moves the bracket 180 upwards, the upper edge 140b interacts with the stop surface 195 and, if sufficient force is applied to overcome the force of the biasing mechanism 198, the upper latch 191 rotates about its rotational axis into its unlatched position. As the bracket 180 and pawl 170 move upwards along the axis 141 towards the upper edge 140b, the upper edge 140b next interacts with the chamfered surface 179 of the tab 175, which in turn causes the pawl 170 to rotate about its axis of rotation. The track 100 would then keep the pawl 170 and the first extension 194 rotated as illustrated in FIG. 15 until the pawl 170 and the first extension reach the next adjacent aperture 140. Upon reaching the next aperture 140, the force of the biasing mechanism 198 would urge the upper latch 191 to rotate in the direction X, which in turn would cause the pawl 170 to rotate, as discussed above, so that both the support surface 176 and the stop surface 195 can rest upon the bottom edge 140a and interact with the upper edge 140b, respectively, in their latched positions (FIG. 17). The process then can be repeated for further movement of the bracket 180 and the pawl 170 in an upwards direction.

While particular elements, embodiments, and applications of the present invention have been shown and described, it is understood that the disclosure is not limited thereto because modifications may be made by those skilled in the art, particularly in light of the foregoing teaching. It is therefore contemplated by the appended claims to cover such modifications and incorporate those features which come within the spirit and scope of the disclosure.

1. A captive beam system, comprising:
a beam assembly comprising a beam and slidably receiving a first channel unit at a first end of the beam and slidably receiving a second channel unit at a second end of the beam, the beam comprising a top surface that, when the captive beam system is installed, faces upward, wherein the top surface establishes a flat resting surface,
each of the first and second channel units comprises a first end and a second end, the second end slidably engages a respective first or second end of the beam, the first end of each channel unit extends away from the respective end of the beam, the first end of each channel unit supports a bracket and a pawl, the pawl is rotatable with respect to the first end of the channel unit,
wherein the pawl comprises a support surface that is configured, when the captive beam system is installed, to rest upon a bottom edge of an aperture disposed within a fixed track, wherein a vertical distance between the support surface and the flat resting surface of the beam is about 2.58 inches.

2. The captive beam system of claim 1, wherein the pawl and the bracket are each connected to the first end of the channel unit with a pin, wherein the bracket is rotatable with respect to the first end of the channel unit and with respect to the pawl.

3. The captive beam system of claim 1, wherein the pawl comprises an operator that is positioned in a spaced position from the support surface, and on an opposite side of the support surface from a position where the pawl rotatably connects to the channel unit.

4. The captive beam system of claim 3, wherein the pawl is biased with respect to the first end of the channel unit in a direction such that the operator is biased away from the first end of the channel unit.

5. The captive beam system of claim 3, wherein the bracket comprises two feet that extend away from each other.

6. The captive beam system 5, wherein the two feet are configured to slide within opposite portions of a fixed vertical track.

7. The captive beam system of claim 6, wherein the fixed vertical track has a plurality of apertures spaced therealong, the plurality of apertures are disposed between the opposite portions of the fixed vertical track that receive the two feet of the bracket, wherein the pawl is biased with respect to the first end of the channel unit in a direction such that a tab of the pawl, which includes the support surface, is biased into an aperture of the plurality of apertures that is aligned with the tab and the support surface rests upon a bottom edge of the aligned aperture.

8. The captive beam system of claim 1, wherein the system is configured to be installed in an environment with a plurality of identical vertical tracks disposed along the same wall, wherein at least two of the plurality of identical vertical tracks are disposed such that a bottom edge of an aperture in the at least two vertical tracks is disposed at the same vertical height above a floor of an enclosure, such that when a conventional E-beam is engaged with the bottom edge of the aperture in a first of the at least two vertical tracks, and the beam assembly is disposed such that the support surface of the pawl is engaged with the bottom edge of the aperture in the second of the at least two vertical tracks, a top surface of the E-beam is disposed along a horizontal plane with the flat resting surface of the beam.

9. A captive beam system comprising:
a set of supports comprising first and second tracks each extending between first end and a second end, the first and second tracks each configured for fixed attachment to walls of a container, the first and second tracks both comprising a race disposed therealong and extending from the first end at least to a position proximate to the second end of the respective support, and each of the first and second supports comprising a plurality of aligned apertures disposed through a center wall of the support with the plurality of apertures each comprising a bottom edge,
a beam assembly comprising a beam and slidably receiving a first channel unit at a first end of the beam and slidably receiving a second channel unit at a second end of the beam, the beam comprising a top surface that, when the captive beam system is installed, faces upward, wherein the top surface establishes a flat resting surface,
each of the first and second channel units comprises a first end and a second end, the second end slidably engages a respective first or second end of the beam, the first end of each channel unit extends away from the respective end of the beam and engages a respective one of the first and second supports, the first end of each channel unit supports a bracket and a pawl, the pawl is rotatable with respect to the first end of the channel unit,
wherein the pawl comprises a support surface that is configured, when the captive beam system is installed, to rest upon the bottom edge of one of the plurality of apertures in the respective support, wherein a vertical distance between the support surface and the flat resting surface of the beam is about 2.58 inches.

10. The captive beam system of claim 9, wherein each bracket includes a foot that is slidably received within the race of the first or second track to which the respective bracket is engaged.

11. The captive beam system of claim 9, wherein the pawl comprises an operator that extends below the support surface and on an opposite side of the support surface from a connection between the pawl and the channel unit, wherein the pawl is biased with respect to the first end of the channel unit in a direction such that the operator is biased away from the first end of the channel unit.

12. The captive beam system of claim 9, wherein at least two sets of supports with the same construction are disposed in a neighboring relationship and with respective first supports from the at least two sets of supports are disposed proximate to each other and such that the bottom edge of one of the plurality of apertures on each of the respective first supports is disposed at the same vertical height above a floor of an enclosure, such that when a conventional E-beam is engaged with the bottom edge of the aperture of one of the respective first supports, and the beam assembly is disposed such that the support surface of the pawl is engaged with the bottom edge of the aperture in the other of the respective first supports, a top surface of the E-beam is disposed along a horizontal plane with the flat resting surface of the beam.

13. The captive beam system of claim 1, further comprising an upper latch configured to be rotatable with respect to the bracket, the upper latch including a first extension with a stop surface that is configured, when the captive beam is installed, to lie proximate to an upper edge of the aperture so as to substantially prevent movement of the beam assembly in a direction along a long axis of the aperture.

14. A captive beam system to be installed along at least one fixed track,
wherein the fixed track includes at least one aperture with an upper edge and a bottom edge spaced apart from the upper edge and a long axis extending between the upper edge and the lower edge, the captive beam system comprising:
a beam assembly comprising a beam and slidably receiving a first channel unit at a first end of the beam and slidably receiving a second channel unit at a second end of the beam, the beam comprising a top surface that, when the captive beam system is installed, faces upward, wherein the top surface establishes a flat resting surface, and wherein each of the first channel unit and the second channel unit includes a first end and a second end spaced apart from the first end, wherein the second end of each of the first channel unit and the second channel unit slidably engages a respective first end and second end of the beam;
a bracket coupled to one of the first end of the first channel unit and the first end of the second channel unit;
a pawl configured to be rotatable with respect to the bracket, the pawl including a support surface that is configured, when the captive beam system is installed, to rest upon the bottom edge of the at least one aperture;
an upper latch configured to be rotatable with respect to the bracket, the upper latch including a first extension with a stop surface that is configured, when the captive beam is installed, to lie proximate to the upper edge of the at least one aperture so as to substantially prevent movement of the beam assembly in a direction along the long axis of the aperture.

15. The captive beam system of claim 14, wherein the pawl and the bracket are each connected to the first end of the channel unit with a pin, wherein the bracket is rotatable with respect to the first end of the channel unit and with respect to the pawl.

16. The captive beam system of claim 14, wherein the pawl and the upper latch are rotatable relative to the bracket around different axes of rotation.

17. The captive beam system 14, wherein the first extension of the upper latch includes a first axis, and wherein the upper latch includes a second extension with a second axis that intersects the first axis at an angle.

18. The captive beam system of claim 17, wherein the angle is obtuse.

19. The captive beam system of claim 14, wherein the pawl comprises an operator that is positioned in a spaced position from the support surface, and on an opposite side of the support surface from a position where the pawl rotatably connects to the channel unit.

20. The captive beam system of claim 19, further comprising a biasing mechanism coupled to one of the pawl and the upper latch, wherein the biasing mechanism is configured to urge the operator away from one of the first channel unit and the second channel unit.

21. The captive beam system of claim 20, wherein the biasing mechanism comprises a torsion spring coupled to the upper latch.

22. The captive beam system of claim 19, wherein the pawl comprises an upper end spaced apart from the operator, wherein the upper end includes a recess on a lower surface configured to receive a central portion of the upper latch when the support surface of the pawl does not rest upon the lower edge of the aperture.

23. The captive beam system of claim 22, wherein the upper latch includes a second extension with an engagement surface configured to interact with a pawl engagement surface on the upper end of the pawl such that the upper latch and the pawl are rotatably coupled.

24. A slidable locking system to be installed along at least one fixed track, wherein the fixed track includes at least one aperture with an upper edge and a bottom edge spaced apart from the upper edge and a long axis extending between the upper edge and the lower edge and at least one race, the slidable locking system comprising: a bracket that includes:
a first side;
a second side spaced apart from the first side, the second side being coupled to the first side by at least a center member, wherein the first side and the second side form a channel;
at least one foot configured to be slidably received within the at least one race of the fixed track;
a pawl rotatably coupled to the bracket, the pawl including a support surface that is configured to rest upon the bottom edge of the at least one aperture when the pawl is in a latched position;
an upper latch rotatably coupled to the bracket, the upper latch including a first extension with a stop surface that is configured to lie proximate to the upper edge of the at least one aperture so as to substantially prevent movement of the bracket in a direction along the long axis of the aperture when the upper latch is in a latched position.

25. The slidable locking system of claim 24, wherein the bracket further comprises at least two holes extending through each of the first side and the second side, wherein the pawl includes at least one through hole, and wherein the upper latch includes at least another through hole, wherein the slidable locking system further comprises a first pin that extends through one of the at least two holes extending through the bracket and the through hole of the pawl and a second pin that extends through the other of the at least two holes extending through the bracket and the another through hole of the upper latch.

26. The slidable locking system of claim 24, wherein the pawl and the upper latch are rotatable relative to the bracket around different axes of rotation.

27. The slidable locking system of claim 24, wherein the first extension of the upper latch includes a first axis, and wherein the upper latch includes a second extension with a second axis that intersects the first axis at an angle.

28. The slidable locking system of claim 27, wherein the angle is obtuse.

29. The slidable locking system of claim 24, wherein the pawl comprises an operator that is positioned in a spaced position from the support surface, and on an opposite side of the support surface from a position where the pawl rotatably connects to the bracket.

30. The slidable locking system of claim 29, further comprising a biasing mechanism coupled to one of the pawl and the upper latch, wherein the biasing mechanism is configured to urge the operator towards the fixed track.

31. The slidable locking system of claim 30, wherein the biasing mechanism comprises a torsion spring coupled to the upper latch.

32. The slidable locking system of claim 29, wherein the pawl comprises an upper end spaced apart from the operator, wherein the upper end includes a recess on a lower surface configured to receive a central portion of the upper latch when the support surface of the pawl does not rest upon the lower edge of the aperture.

33. The slidable locking system of claim 32, wherein the upper latch includes a second extension with an engagement surface configured to interact with a pawl engagement surface on the upper end of the pawl such that the upper latch and the pawl are rotatably coupled.

34. The slidable locking system of claim 24, wherein the bracket further comprises a rear member spaced apart from the center member, the rear member and the center member defining an opening through which the first extension of the upper latch rotates.
